(19) United States
(12) Patent Application Publication
(10) Pub. No.: US 2026/0019124 A1
(43) Pub. Date: Jan. 15, 2026

(54) METHODS FOR HIERARCHICAL BEAM PREDICTION BASED ON MULTIPLE CRI

(71) Applicant: InterDigital Patent Holdings, Inc., Wilmington, DE (US)

(72) Inventors: Nazli Khan Beigi, Longueuil (CA); Young Woo Kwak, Woodbury, NY (US); Patrick Tooher, Montreal (CA); Yugeswar Deenoo Narayanan Thangaraj, Chalfont, PA (US); Moon IL Lee, Melville, NY (US); Tejaswinee Lutchoomun, Montreal (CA)

(73) Assignee: InterDigital Patent Holdings, Inc., Wilmington, DE (US)

(21) Appl. No.: 18/994,492

(22) PCT Filed: Jul. 10, 2023
(86) PCT No.: PCT/US2023/027264

§ 371 Date: Jan. 14, 2025

Related U.S. Application Data
(60) Provisional application No. 63/393,060, filed on Jul. 28, 2022.

(51) Int. Cl. H04B 7/06; H04B 17/318

(52) U.S. Cl. CPC H04B 7/0626; H04B 7/0632; H04B 17/328

(57) ABSTRACT

A wireless transmit/receive unit (WTRU) comprising a processor configured to receive configuration information, wherein the configuration information indicates channel state information (CSI) reporting parameters used for reporting a plurality of CSI reference signal (CSI-RS) resource indicators (CRIs), and wherein the configuration information indicates one or more parameters used to determine a number of CRIs to report, the one or more parameters comprising at least one of a reference signal received power (RSRP) threshold or a line of sight (LOS) probability threshold, determine CSI parameters for a first set of configured CSI-RS resources associated with a first CRI, determine CSI parameters for one or more additional sets of configured CSI-RS resources associated with one or more additional CRIs, and transmit the CSI parameters associated with the first CRI and the CSI parameters associated with the one or more additional CRIs.

### CROSS-REFERENCE TO RELATED APPLICATIONS

This application claims the benefit of U.S. Provisional Application No. 63/393,060, filed on Jul. 28, 2022, the entire contents of which are incorporated herein by reference.

### BACKGROUND

Techniques are being studied for modifying radio access network (RAN) procedures to facilitate the use of Artificial Intelligence (AI)/Machine Learning (ML) techniques to improve the new radio (NR) air interface. One example use-case for AI/ML for air interface improvements includes beam management procedures. It is contemplated that this technology may serve as the foundation for improving performance and complexity in conventional beam management aspects, including beam prediction in time and/or spatial domain for overhead and latency reduction, beam selection accuracy improvement, and so forth.

Beam management was selected as one of the target use cases for AI/ML for the air interface. It is contemplated that this technology may serve as a foundation for improving performance and complexity in conventional beam management aspects, including beam prediction in time and/or spatial domain for overhead and latency reduction, beam selection accuracy improvement, and so forth.

A conventional beam selection may be based on beam sweeping on a network-side in a first frequency range (FR1), such as between a base station (gNodeB or gNB (in NR)) and a wireless transmit/receive unit (WTRU) side. In a second frequency range (FR2), the conventional beam management may result in beam sweeping and measurement over a large number of antennas. Upon selection of the best beams, the WTRU may report up to four beams (e.g., based on reference signal received power (RSRP)) in a beam management procedure.

### SUMMARY

A WTRU may include a processor configured to implement a method to support hierarchical beam prediction based on multiple CRIs. The processor may be configured to receive configuration information. The configuration information may indicate channel state information (CSI) reporting parameters used for reporting a plurality of CSI reference signal (CSI-RS) resource indicators (CRIs). The configuration information may further indicate one or more parameters used to determine a number of CRIs to report, the one or more parameters comprising at least one of a reference signal received power (RSRP) threshold or a line of sight (LOS) probability threshold.

The processor may be further configured to determine CSI parameters for a first set of configured CSI-RS resources associated with a first CRI. The processor may be further configured to determine CSI parameters for one or more additional sets of configured CSI-RS resources associated with one or more additional CRIs based on at least one of a RSRP being greater than the RSRP threshold for at least two CRIs associated with respective sets of CSI reporting parameters, or a determined LOS probability for the CSI parameter associated with the first set of configured CSI-RS resources being greater than the LOS probability threshold. Lastly, the WTRU may be configured to transmit the CSI parameters associated with the first CRI and the CSI parameters associated with the one or more additional CRIs.

The configuration information may indicate a maximum value for the plurality of CRIs. The configuration information may indicate one or more priority levels for selecting the one or more additional CRIs.

The priority levels may comprise one or more of a RSRP criteria, a LOS indication criteria, or a LOS probability criteria. The priority levels comprise one or more use cases for the additional sets of CSI-RS resources.

The CSI parameters for the one or more additional sets of CSI-RS resources associated with the one or more additional CRIs may be determined further based on a schedule for an uplink resource or the uplink resource type.

The first CRI and the CSI parameters associated with the first CRI may be transmitted in a first feedback resource, and the one or more additional CRIs and the CSI parameters associated with the one or more additional CRIs may be transmitted in a second feedback resource. The one or more additional CRIs may be associated with a second set of configured CSI-RS resources, and the second set of CSI-RS resources may be determined based on one or more of a priority, RSRP measurements, or a LOS probability. The CSI parameters associated with the first CRI may comprise channel quality indication (CQI) feedback, precoding matrix indices (PMI), a rank indicator (RI), or a layer index (LI). The CSI parameters associated with the one or more additional CRIs may comprise CQI feedback, PMI, a RI, or a LI.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 illustrates a system where a WTRU is configured with a first set of beam resources in a first frequency range and/or a first beamwidth.

FIG. 3 illustrates embodiments for supporting multiple CSIs for CSI measurement in beam prediction.

FIG. 4 is a flow chart for a procedure for a WTRU for supporting multiple CRIs in CSI measurement and reporting.

### DETAILED DESCRIPTION

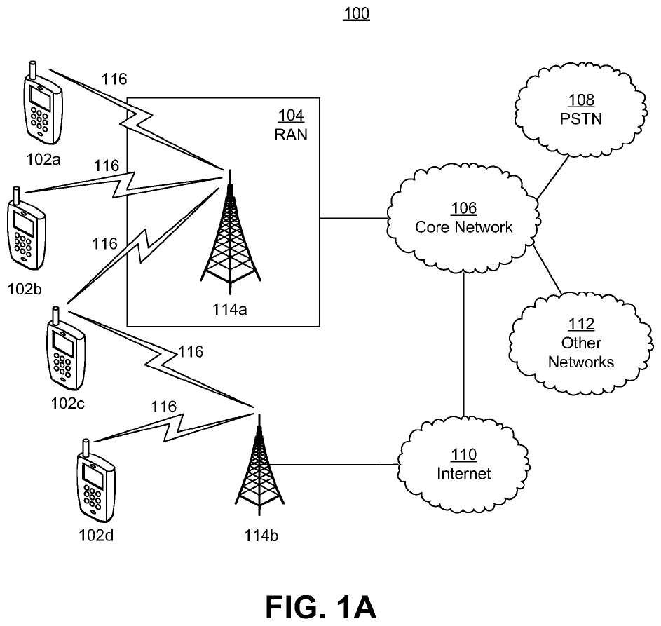

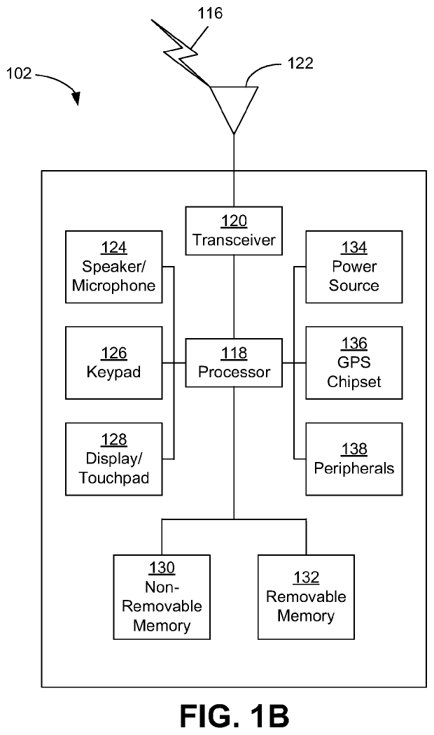

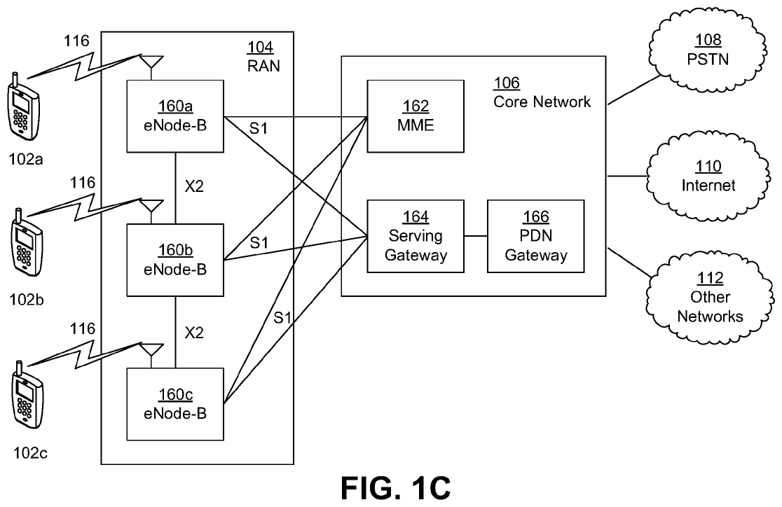

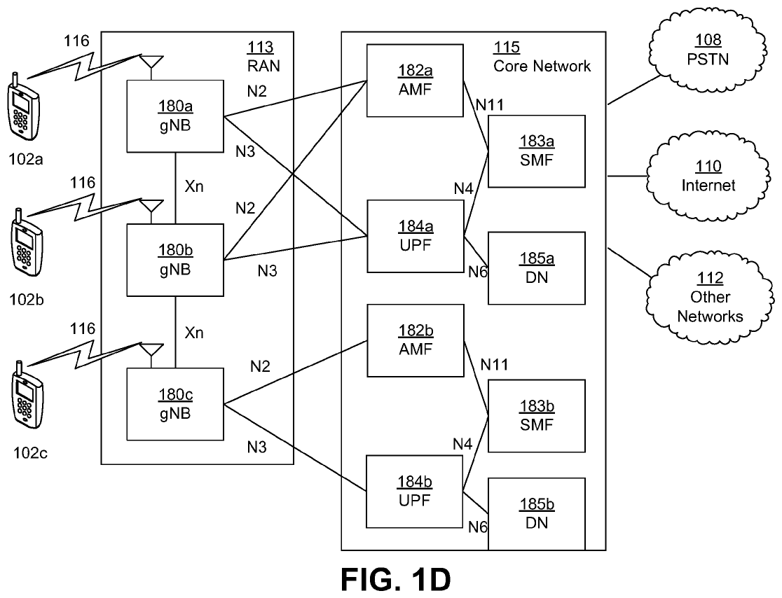

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112. However, it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA,” may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c, 102d may be interchangeably referred to as a WTRU.

The communications systems 100 may include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in a licensed spectrum, an unlicensed spectrum, or a combination of licensed and unlicensed spectrums. A cell may provide coverage for a wireless service to a specific geographical area that may be relatively fixed, or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple-output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR, etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b. 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP), and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134 and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality, and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor, a geolocation sensor, an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements is depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attachment of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166. which may provide the WTRUs 102a, 102b, 102c with access to packet-switched networks, such as the Internet 110, to facilitate communications between the WTRUs 102a, 102b, 102c, and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c, and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c access to the other networks 112, which may include other wired and/or wireless networks owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP, and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operation, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented. for example, in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz and/or 80 MHz channels may be formed by combining contiguous 20 MHz channels. A 160 MHz channel may be formed by combining 8 contiguous 20 MHz channels or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities, including support for (e.g., only support for) certain and/or limited bandwidths. The MTC devices may include a battery with a battery life above a threshold (e.g., to maintain a very long battery life).

WLAN systems, which may support multiple channels and channel bandwidths, such as 802.11n, 802.11ac, 802.11af, and 802.11ah, include a channel that may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS. which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remain idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b. 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells. and/or different portions of the wireless transmission spectrum. The WTRUs 102a, 102b, 102c may communicate with gNBs 180a, 180b. 180c using subframe or transmission time intervals (TTIs) of various or scalable lengths (e.g., containing varying numbers of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c, and one or more eNode-Bs 160a, 160b, 160c substantially simultaneously. In the non-standalone configuration, eNode-Bs 160a, 160b, 160c may serve as a mobility anchor for WTRUs 102a, 102b, 102c, and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a. 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements is depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases, such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP addresses, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein. may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may perform testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

As used herein, absent an alternate definition or explanation being provided, the terms ‘a’ and ‘an’ and similar phrases are to be interpreted as ‘one or more’ and ‘at least one.’ Similarly, any term which ends with the suffix ‘s’ or ‘(s)’ is to be interpreted as ‘one or more’ and ‘at least one.’ The term ‘may’ is to be interpreted as ‘may, for example.’

In addition, the following terms, absent an alternate definition or explanation being provided, are herein defined.

Artificial Intelligence (AI) may be broadly defined as the behavior exhibited by machines. Such behavior may e.g., mimic cognitive functions to sense, reason, adapt and act. Machine Learning (ML) may refer to a type of algorithm that solves a problem based on learning through experience (‘data’), without explicitly being programmed (‘configuring a set of rules’). Machine learning may be considered as a subset of AI. Different machine learning paradigms may be envisioned based on the nature of data or feedback available to the learning algorithm. For example, a supervised learning approach may involve learning a function that maps input to an output based on labeled training examples, wherein each training example may be a pair consisting of an input and a corresponding output. For example, an unsupervised learning approach may involve detecting patterns in the data with no pre-existing labels. For example, a reinforcement learning approach may involve performing a sequence of actions in an environment to maximize the cumulative reward. In some embodiments, it is possible to apply machine learning algorithms using a combination or interpolation of the above-mentioned approaches. For example, a semi-supervised learning approach may use a combination of a small amount of labeled data with a large amount of unlabeled data during training. In this regard, semi-supervised learning falls between unsupervised learning (with no labeled training data) and supervised learning (with only labeled training data).

Artificial Intelligence/Machine Learning (AI/ML) refers to methods/processing and the realization of behaviors and/or conformance to requirements by learning based on data, without explicit configuration of a sequence of steps of actions. Such methods may enable learning complex behaviors which might be difficult to specify and/or implement when using legacy methods.

Deep Learning (DL) refers to a class of machine learning algorithms that employ artificial neural networks (specifically DNNs), which were loosely inspired from biological systems.

Deep Neural Networks (DNNs) are a special class of machine learning models inspired by the human brain wherein the input is linearly transformed and pass-through non-linear activation function multiple times. DNNs typically consist of multiple layers, where each layer consists of linear transformation and a given non-linear activation function. The DNNs may be trained using the training data via a back-propagation algorithm. Recently, DNNs have shown state-of-the-art performance in a variety of domains, e.g., speech, vision, natural language, etc., and for various machine learning settings supervised, un-supervised, and semi-supervised.

Beam may be used to refer to a spatial domain filter. A WTRU may transmit or receive a physical channel or reference signal according to at least one spatial domain filter. The WTRU may transmit a physical channel or signal using the same spatial domain filter as the spatial domain filter used for receiving an RS (such as a CSI reference signal (CSI-RS)) or a SS block. The WTRU transmission may be referred to as “target” and the received RS or SS block may be referred to as “reference” or “source.” In such cases, the WTRU may be said to transmit the target physical channel or signal according to a “spatial relation” with a reference to such RS or SS block. The WTRU may transmit a first physical channel or signal according to the same spatial domain filter as the spatial domain filter used for transmitting a second physical channel or signal. The first and second transmissions may be referred to as “target” and “reference” (or “source”), respectively. In such cases, the WTRU may be said to transmit the first (target) physical channel or signal according to a spatial relation with a reference to the second (reference) physical channel or signal. A spatial relation may be implicit, configured by RRC or signaled by MAC CE or DCI. For example, a WTRU may implicitly transmit PUSCH and DM-RS of PUSCH according to the same spatial domain filter as an SRS indicated by an SRI indicated in DCI or configured by RRC. As another example, a spatial relation may be configured by RRC for an SRS resource indicator (SRI) or signaled by MAC CE for a PUCCH. Such spatial relation may also be referred to as a “beam indication.” The WTRU may receive a first (target) downlink channel or signal according to the same spatial domain filter or spatial reception parameter as a second (reference) downlink channel or signal. For example, such association may exist between a physical channel such as PDCCH or PDSCH and its respective DM-RS. At least when the first and second signals are reference signals, such association may exist when the WTRU is configured with a quasi-colocation (QCL) assumption type D between corresponding antenna ports. Such association may be configured as a TCI (transmission configuration indicator) state. A WTRU may be indicated an association between a CSI-RS or SS block and a DM-RS by an index to a set of TCI states configured by RRC and/or signaled by MAC CE. Such indications may also be referred to as a “beam indication.”

Transmission and reception point (TRP, MTRP, M-TRP) may be interchangeably used with one or more of TP (transmission point), RP (reception point), RRH (radio remote head), DA (distributed antenna), BS (base station), a sector (of a BS), and a cell (e.g., a geographical cell area served by a BS). Hereafter, Multi-TRP may be interchangeably used with one or more of MTRP, M-TRP, and multiple TRPs.

Channel state information (CSI) components may correspond to at least a CSI-RS resource indicator (CRI), a SSB resource indicator (SSBRI), an indication of a panel used for reception at the WTRU (such as a panel identity or group identity), measurements such as L1-RSRP, L1-SINR taken from SSB or CSI-RS (e.g., cri-RSRP, cri-SINR, ssb-Index-RSRP, ssb-Index-SINR), and other channel state information such as at least rank indicator (RI), channel quality indicator (CQI), precoding matrix indicator (PMI), Layer Index (LI), and/or the like. A WTRU may report a subset of the CSI components.

Channel and/or Interference Measurements (SSB) are defined where a WTRU may receive a synchronization signal/physical broadcast channel (SS/PBCH) block. The SS/PBCH block (SSB) may include a primary synchronization signal (PSS), a secondary synchronization signal (SSS), and a physical broadcast channel (PBCH). The WTRU may monitor, receive, or attempt to decode an SSB during initial access, initial synchronization, radio link monitoring (RLM), cell search, cell switching, and so forth.

Channel state information-reference signals (CSI-RS) is used whereby a WTRU may measure and report the CSI, wherein the CSI for each connection mode may include or be configured with one or more of (1) CSI Report Configuration (including one or more of the CSI report quantity, e.g., Channel Quality Indicator (CQI), Rank Indicator (RI), Precoding Matrix Indicator (PMI), CSI-RS Resource Indicator (CRI), Layer Indicator (LI), etc.; the CSI report type, e.g., aperiodic, semi persistent, periodic; the CSI report codebook configuration, e.g., Type I, Type II, Type II port selection, etc.; and the CSI report frequency.); (2) CSI-RS Resource Set (including one or more of the following CSI Resource settings NZP-CSI-RS Resource for channel measurement; NZP-CSI-RS Resource for interference measurement; and CSI-IM Resource for interference measurement); and (3) NZP CSI-RS Resources (including one or more of the NZP CSI-RS Resource ID: periodicity and offset; QCL Info and TCI-state and resource mapping, e.g., number of ports, density, CDM type, etc.)

Using AI/ML models, the second frequency range (FR2) beam selection/prediction can be performed based on the first frequency range (FR1) channel state information (CSI) measurements and reporting. Currently, FR1 CSI is designed for FR1 operation and not for efficiently training an association between FR1 CSI and FR2 beam information. For example, multiple CSI reference signal (RS) resource indicators (CRIs)/precoding matrix indicators (PMIs) for multiple beams are needed for training FR1 CSI for FR2 beam prediction. However, the current CSI does not support multiple CRIs/PMIs. Multiple CRIs are supported only for FR2 beam information (e.g., cri-L1-RSRP).

The realization of beam management and beam predictions based on the AI/ML framework may be subject to resolving challenges in beam measurement and reporting, as well as potential training and validation of the AI/ML model in scenarios with hierarchical spatial relations and beam associations in different frequency ranges. This may result in different WTRU behavior in determining the associations, measuring, and reporting the beam resources, as well as training, validation, activation and/or deactivation of the AI/ML models.

A WTRU may indicate, determine, or be configured with one or more reference signals (RS). The WTRU may monitor, receive, and measure one or more parameters based on the respective reference signals. For example, one or more of the following may apply. The following parameters are non-limiting examples of the parameters that may be included in reference signal(s) measurements. One or more of these parameters may be included. Other parameters may be included.

The SS reference signal received power (SS-RSRP) may be measured based on the synchronization signals (e.g., demodulation reference signal (DMRS) in PBCH or SSS). It may be defined as the linear average over the power contribution of the resource elements (RE) that carry the respective synchronization signal. In measuring the RSRP, power scaling for the reference signals may be required. In case SS-RSRP is used for L1-RSRP, the measurement may be accomplished based on CSI reference signals in addition to the synchronization signals.

CSI-RSRP may be measured based on the linear average over the power contribution of the resource elements (RE) that carry the respective CSI-RS. The CSI-RSRP measurement may be configured within measurement resources for the configured CSI-RS occasions.

SS signal-to-noise and interference ratio (SS-SINR) may be measured based on the synchronization signals (e.g., DMRS in PBCH or SSS). It may be defined as the linear average over the power contribution of the resource elements (RE) that carry the respective synchronization signal divided by the linear average of the noise and interference power contribution. In case SS-SINR is used for L1-SINR, the noise and interference power measurement may be accomplished based on resources configured by higher layers.

CSI-SINR may be measured based on the linear average over the power contribution of the resource elements (RE) that carry the respective CSI-RS divided by the linear average of the noise and interference power contribution. In case CSI-SINR is used for L1-SINR, the noise and interference power measurement may be accomplished based on resources configured by higher layers. Otherwise, the noise and interference power may be measured based on the resources that carry the respective CSI-RS.

Received signal strength indicator (RSSI) may be measured based on the average of the total power contribution in configured OFDM symbols and bandwidth. The power contribution may be received from different resources (e.g., co-channel serving and non-serving cells, adjacent channel interference, thermal noise, and so forth).

Cross-Layer interference received signal strength indicator (CLI-RSSI) may be measured based on the average of the total power contribution in configured OFDM symbols of the configured time and frequency resources. The power contribution may be received from different resources (e.g., cross-layer interference, co-channel serving and non-serving cells, adjacent channel interference, thermal noise, and so forth).

Sounding reference signals RSRP (SRS-RSRP) may be measured based on the linear average over the power contribution of the resource elements (RE) that carry the respective SRS.

A Beam/CSI report configuration (e.g., CSI-ReportConfigs) may be associated with a single BWP (e.g., indicated by BWP-Id), wherein one or more of the following parameters are configured: (1) CSI-RS resources and/or CSI-RS resource sets for channel and interference measurement; (2) CSI-RS report configuration type including the periodic, semi-persistent, and aperiodic, (3) CSI-RS transmission periodicity for periodic and semi-persistent CSI reports, (4) CSI-RS transmission slot offset for periodic, semi-persistent and aperiodic CSI reports, (5) CSI-RS transmission slot offset list for semi-persistent and aperiodic CSI reports (6) time restrictions for channel and interference measurements, (7) report frequency band configuration (wideband/sub band CQI, PMI. and so forth), (8) thresholds and modes of calculations for the reporting quantities (CQI, RSRP, SINR, LI, RI, etc.), (9) codebook configuration, (10) group based beam reporting, (11) CQI table, (12) sub band size, (13) non-PMI port indication, and (14) port Index.

A CSI-RS Resource Set (e.g., NZP-CSI-RS-ResourceSet) may include one or more of CSI-RS resources (e.g., NZP-CSI-RS-Resource and CSI-ResourceConfig), wherein a WTRU may be configured with one or more of the following in a CSI-RS Resource: (1) CSI-RS periodicity and slot offset for periodic and semi-persistent CSI-RS Resources, (2) CSI-RS resource mapping to define the number of CSI-RS ports, density, CDM-type, OFDM symbol, and subcarrier occupancy, (3) The bandwidth part to which the configured CSI-RS is allocated, and (4) The reference to the TCI-State including the QCL source RS(s) and the corresponding QCL type(s).

RS resource set configuration may be defined by a WTRU configured with one or more RS resource sets: (1) RS resource set ID, (2) one or more RS resources for the RS resource set, (3) repetition (i.e., on or off), (4) aperiodic triggering offset (e.g., one of 0-6 slots), and TRS info (e.g., true or not).

RS resource configuration may be defined by one or more of the following configurations for RS resource within a WTRU: (1) RS resource ID, (2) resource mapping (e.g., REs in a PRB), (3) power control offset (e.g., one value of −8, . . . , 15), (4) power control offset with SS (e.g., −3 dB, 0 dB, 3 dB, 6 Db), (5) scrambling ID, (6) periodicity and offset, and (7) QCL information (e.g., based on a TCI state).

A property of a grant or assignment may consist of at least one of the following: (1) a frequency allocation; (2) an aspect of time allocation, such as a duration; (3) a priority; (4) a modulation and coding scheme; (5) a transport block size; (6) a number of spatial layers; (7) a number of transport blocks; (8) a TCI state, CRI or SRI; (9) a number of repetitions; (10) whether the repetition scheme is Type A or Type B; (11) whether the grant is a configured grant type 1, type 2 or a dynamic grant; (12) whether the assignment is a dynamic assignment or a semi-persistent scheduling (configured) assignment; (13) a configured grant index or a semi-persistent assignment index; (14) a periodicity of a configured grant or assignment; (15) a channel access priority class (CAPC); and (16) any parameter provided in a DCI, by MAC or by RRC for the scheduling the grant or assignment.

An indication by DCI may consist of at least one of an explicit indication by a DCI field or by RNTI used to mask CRC of the PDCCH and an implicit indication by a property such as DCI format, DCI size, Coreset or search space, Aggregation Level, first resource element of the received DCI (e.g., index of first Control Channel Element), where the mapping between the property and the value may be signaled by RRC or MAC.

Further. the reference signal (RS) term may be interchangeably used with one or more of the RS resource, RS resource set, RS port, and RS port group. RS may also be interchangeably used with one or more of SSB, CSI-RS, SRS, DM-RS, TRS, PRS, and PTRS.

A channel may be interchangeably used with one or more of PDCCH, PDSCH, physical uplink control channel (PUCCH), physical uplink shared channel (PUSCH), and physical random access channel (PRACH).

In addition to the foregoing, it may be understood that an RS resource set may be interchangeably used with a RS resource and a beam group. Further, beam reporting may be interchangeably used with CSI measurement, CSI reporting, and beam measurement. Beam resources prediction may be used for beam resources belonging to a single or multiple cells as well as single or multiple TRPs. A beam resource may consist of a TCI state, CSI-RS or a SSB for downlink, an SRS resource, or a TCI state for uplink. Also, CSI-RS resource indicator (CRI) may be interchangeably used with beam resource or beam resource indicator. In addition, the frequency range may be interchangeably used with beamwidth.

A WTRU may receive one or more CSI report configurations (e.g., CSI-ReportConfig). A CSI report configuration may include a CSI report quantity that may indicate the CSI parameters that may be required to be measured (e.g., estimated or derived) and reported. As an example, CSI report quantity could be one or more of the Channel Quality Indicator (CQI), Rank Indicator (RI), Precoding Matrix Indicator (PMI), CSI-RS Resource Indicator (CRI), Layer Indicator (LI), Signal-to-Noise and Interference Ratio (SINR), Reference Signal Received Power (RSRP), and so forth.

The CSI report configuration may be associated with one or more CSI resource settings (e.g., CSI-ResourceConfig) for channel/interference measurement. A resource setting may include a list of CSI Resource Sets, where the list may comprise references to one or more CSI-RS resource sets and/or SS/PBCH block (SSB) sets. The WTRU may perform measurements on one or more CSI-RS resources and derive one or more CSI parameters. For example, during the beam selection, the WTRU may measure and derive received power and report (e.g., CRI-RSRP/L1-RSRP) for one or more beam resources (e.g., up to four CRI-RSRP/L1-RSRP with highest RSRP). As another example, the WTRU may determine a CRI (e.g., based on a priority such as CQI, RSRP, and so forth) from the supported/configured set of CRI values and report CRI along with one or more CSI parameters for the determined CRI. As such, the WTRU may measure and derive one or more CSI parameters for the determined CRI, conditioned on the reported CRI.

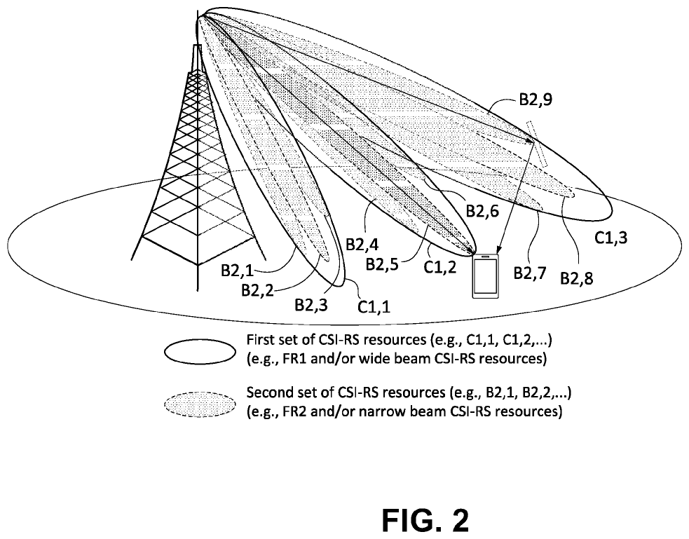

FIG. 2 illustrates a system where a WTRU is configured with a first set of beam resources in a first frequency range and/or a first beamwidth. FIG. 2 shows a system where a WTRU may be configured with a first set of beam resources (e.g., CSI-RS resources, TCI states, etc.) in a first frequency range (e.g., FR1) and/or a first beamwidth (e.g., wide beamwidth). For example, the first set of beams may be called C1,1, C1,2, and C1,3 in FIG. 2. The WTRU may also be configured with a second set of beam resources (e.g., CSI-RS, TCI State, etc.) in a second frequency range (e.g., FR2) and/or a second beamwidth (e.g., narrow beamwidth). The second set of beams may be called B_{2,1}-B_{2,3}, B_{2,4}-B_{2,6}, and B_{2,7}-B_{2,9} in FIG. 2, for example. In FIG. 2, the best beam directions for WTRU are exemplified by arrows. The WTRU may determine the best beam resource in the first set of beams may be C_{1,2} (e.g., with highest RSRP or LOS) and the WTRU may report CSI parameters (e.g., RSRP, RI, LI, SINR, PMI, CQI, etc.) for the respective selected C_{1,2} beam.

In addition, the WTRU may determine one or more best beam resources in the second set of beam resources (e.g., CSI-RS resources, TCI states, etc.) in a second frequency range (FR2) and/or a second beamwidth (e.g., wide beamwidth). For example, the best beam resources may be B2,5 and B2,9 in FIG. 2 (e.g., with the highest RSRP). The WTRU may then report the determined/selected beam resources (e.g., beam index or CRIs) and respective RSRP/SINR (e.g., L1-RSRP, L1-SINR, etc.) for up to a maximum number of beams (e.g., up to four beams).

During CSI reporting, the WTRU may report the CSI parameters for a single reported CRI (e.g., only for a single reported CRI). However, more than one beam resource/CRI (e.g., CRI-RSRP/L1-RSRP) may be required to be reported for beam management/selection purposes. Performing beam prediction (e.g., based on AI/ML models) for a second frequency range (e.g., FR2) and/or a second beamwidth (e.g., narrower beamwidth) based on a first frequency range (e.g., FR1) and/or a first beamwidth (e.g., wider beamwidth) may require that the CSI parameters be reported for more than one CSI resource (e.g., multiple CRIs).

The WTRU may be configured to measure and report CSI parameters for more than one beam resource (e.g., CRI). For example, the WTRU may receive configuration information that indicates CSI reporting parameters used for reporting a plurality CRIs. Using the example in FIG. 2, the WTRU may determine to report one or more CSI parameters for more than one beam resource in a first set of CSI-RS resources/beam resources to be used to predict the best CSI-RS resources/beam resources in a second set. The WTRU may determine (e.g., to report) CSI parameters (e.g., PMI, CQI, etc.) for more than one CRI (e.g., C_{1,2} and C_{1,3}). The reported CSI parameters may then be used in, for example, an AI/ML model to predict the best beam resources in the second set (e.g., B_{2,5} and B_{2,9}).

The WTRU may be configured with one or more CSI report configurations that are associated with one or more CSI-RS resources. For example, the WTRU may receive configuration information that indicates the CSI report configurations. The CSI-RS resources may be associated with a first frequency range (e.g., FR1) and/or a first beam width (e.g., wide beamwidth). The CSI report configuration (e.g., configuration information) may include a number of elements. For example, the WTRU may be configured with CSI-ReportConfig with the higher layer parameter CSI reportQuantity set to ‘cri-RI-PMI-CQI’, ‘cri-RI-i1’, ‘cri-RI-i1-CQI’, ‘cri-RI-CQI’, and/or ‘cri-RI-LI-PMI-CQI.’

The CSI report configurations may indicate CSI reporting parameters used for reporting a plurality CRIs. For example, the CSI report configurations may indicate the number of beams to be reported. As such, in some examples, the number of beam/CSI resources to be reported may be configured in the WTRU with nrofReportedRS for the number of CRIs to be reported (e.g., N).

Further. the CSI report configurations may indicate one or more parameters used to determine a number of CRIs to report (e.g., a RSRP threshold or a LOS probability threshold). For example, the CSI report configurations may indicate an indication/probability of LOS. As such, in some examples, the WTRU may be configured with an indication/probability of LOS. The WTRU may use the indication/probability of LOS to determine. indicate and/or report if there is LOS or not for the reported CRIs. Alternatively, or additionally, the WTRU may be configured to determine. indicate and/or report the probability of LOS for the reported CRIs.

The CSI report configurations may indicate a maximum number of CRIs that the WTRU is to report. For example, the WTRU may be configured with a maximum number or limit to the CRIs to be reported (e.g., CRI_N_Max).

The CSI report configurations may indicate a priority indication (e.g., a priority level and/or threshold). As such, the WTRU may be configured with one or more priority levels. For example, the WTRU may determine the number of CRIs to be reported based on one or more determined/configured priorities and respective configured thresholds (e.g., RSRP/SINR threshold(s) and/or LOS threshold(s)). The WTRU may use one or more determined/configured priorities for determining/selecting the CRIs to be reported based on the configured/determined thresholds. For example, the WTRU may determine/indicate/report one or more CRIs with the highest RSRP/SINR, where the determined RSRPs/SINRs are higher than a configured/determined threshold. The WTRU may determine or be configured to provide a priority based indication/probability of LOS to select/indicate/measure/report the CRIs (e.g., only the CRIs) that are associated with a beam resource with LOS. The WTRU may further determine or may be configured to select/indicate/measure/report the CRIs (e.g., only the CRIs) that are associated with a beam resource with the probability of LOS higher than a configured/determined threshold.

The WTRU may be configured with one or more thresholds and/or differential thresholds for determining the priorities (e.g., based on AI/ML model in WTRU/gNB). In addition, the WTRU may be configured with one or more use-cases for the determined multiple CRIs (e.g., beam resource prediction, beam resource association, and/or CSI enhancement).

The WTRU may determine/derive/measure one or more CSI parameters (e.g., LI, CQI, PMI, RSRP, SINR, RI, and so forth) for one or more CSI resources in the first frequency range (e.g., FR1) and/or the first beamwidth (e.g., wider beamwidth). Hence, WTRU may determine the number of CRIs to be reported. For example, the WTRU may determine the priority levels/criteria (e.g., for selecting and reporting CRIs and respective CSI parameters). The WTRU may determine the number of CRIs to be reported (e.g., N), conditioned on the determined number being less than or equal to the maximum limit for the CRIs to be reported (e.g., CRI_N_Max).

The WTRU may determine the number of CRIs to be reported (e.g., N) based on the measurements, priority levels, and configured models/thresholds (e.g., AI/ML model and/or parameters). For example, the number of CRIs may be determined based on measured received power. If there are at least two CRIs with measured received power (e.g., RSRP, SINR, and so forth) higher than a first threshold, the WTRU may determine to report more than one (multiple) CRIs (e.g., N). Otherwise, the WTRU may determine to report only one CRI (e.g., fallback model).

The WTRU may determine a CRI with the highest received power (e.g., RSRP, SINR, and so forth) as the reference CRI (e.g., CRI-RSRP-ref). As an example, the WTRU may determine (e.g., report) one or more CRIs for which the difference between the respective measured received power and the reference CRI's received power (e.g., CRI-RSRP-ref) is lower than a second threshold. In this case, the WTRU may determine to report more than one (multiple) CRIs (e.g., N). Otherwise, the WTRU may determine (e.g., to report) only one CRI (e.g., fallback model).

The WTRU may determine a CRI based on LOS indication/probability. As an example, the WTRU may determine that there may be more than one CRI associated with beam resources with LOS and the WTRU may determine (e.g., to report) more than one (multiple) CRIs (e.g., N). Otherwise. the WTRU may determine (e.g., to report) only one CRI (e.g., fallback model).

As another example, the WTRU may determine that there may be more than one CRI associated with beam resources for which the probability of LOS is higher than a configured/determined threshold, and the WTRU may determine (e.g., to report) more than one (multiple) CRIs (e.g., N). Otherwise. the WTRU may determine (e.g., to report) only one CRI (e.g., fallback model).

The WTRU may determine a CRI based on UL resources for CSI reporting. As an example, the scheduled UL resources for reporting the CRIs and respective CSI parameters may be higher than a threshold and the WTRU may determine (e.g., to report) more than one (multiple) CRIs (e.g., N). Otherwise, the WTRU may determine (e.g., to report) only one CRI (e.g., fallback model). As another example, if the UL resource is a first type (e.g., PUSCH), the WTRU may determine (e.g., to report) more than one (multiple) CRIs (e.g., N). Alternatively, if the UL resource is a second type (e.g., PUCCH), the WTRU may determine (e.g., to report) only one CRI (e.g., fallback model).

The WTRU may determine a CRI based on the activation/deactivation of one or more procedures/parameters (e.g., AI/ML model). As an example, the WTRU may determine that AI/ML model is activated and the WTRU may then determine (e.g., to report) more than one (multiple) CRIs (e.g., N). Otherwise, the WTRU may determine (e.g., to report) only one CRI (e.g., fallback model).

The WTRU may determine the CRIs and their respective CSI parameters based on priorities. As an example, a WTRU may determine the CRIs to be reported from the first set of beam resources (CSI-RS resources, TCI states, etc.) in a first frequency range (e.g., FR1) and/or a first beamwidth (e.g., wide beamwidth).

The WTRU may determine the CRIs from the first set of beams based on determined/configured priorities. As an example, the determination may be based on received power (e.g., RSRP/SINR). The WTRU may select/determine to report multiple CRIs (e.g., N) corresponding to CSI-RS resources with the highest received power (e.g., RSRP, SINR, etc.).

As another example, the WTRU may determine a reference CSI resource based on received power (e.g., with the highest RSRP, SINR, etc.) as the reference CSI resource, e.g., CRI-RSRP-ref. The WTRU may select/determine the other CRIs based on received power. For example, the WTRU may select/determine to report CRIs for which the difference of the respective received power is lower than a threshold compared to the reference CSI resource, e.g., CRI-RSRP-ref.

The WTRU may determine (e.g., to report) the CRIs and their respective CSI parameters based on LOS indication/probability. As an example, the WTRU may select/determine (e.g., to report) the CRIs (e.g., N) corresponding to CSI-RS resources with LOS indication. As another example, the WTRU may determine (e.g., to report) the CRIs (e.g., N) corresponding to CSI-RS resources for which the probability of LOS is higher than a configured/determined threshold. As such, the WTRU may determine a reference CSI resource based on a probability of LOS (e.g., with the highest probability of LOS) as the reference CSI resource, e.g., CRI-LOS-ref. The WTRU may then select/determine the other CRIs based on a probability of LOS. As such, the WTRU may select/determine (e.g., to report) CRIs for which the difference of the respective probability of LOS is lower than a threshold compared to the reference CSI resource, e.g., CRI-LOS-ref.

The WTRU may determine more than one CSI parameter (e.g., PMI) for a single CRI in a first set of configured CSI resources to be reported (e.g., based on determined/configured priorities). The WTRU may order the determined CRIs and their respective CSI parameters based on the determined/configured priority (e.g., LOS, RSRP, and so forth) in a decreasing order. As an example, the WTRU may determine a set of indices for the determined CRIs and their respective CSI parameters (e.g., i=1, 2, N, where i=1 is given to CRI with the highest priority). The WTRU may further report the determined multiple CRIs and their respective CSI-RS resources from the first set of configured CSI-RS resources.

The WTRU may determine the CRIs to be reported based on use-cases. As an example, the WTRU may determine the CRIs to be reported based on use-cases from the first set of beam resources (CSI-RS resources, TCI states, etc.) in a first frequency range (e.g., FR1) and/or a first beamwidth (e.g., wide beamwidth). The WTRU may determine the CRIs and/or the number of CRIs based on determined/configured use cases for the reported multiple CRIs and their respective CSI parameters.

The WTRU may determine the priorities (e.g., RSRP, LOS, etc.) and respective thresholds based on use-cases determined/configured for the reported multiple CRIs and their respective CSI parameters. In such conditions, one or more parameters may be applied. As an example, beam predictions for a second set of beam resources, such as the reported CRIs and their respective CSI parameters in a first frequency range (e.g., FR1) and/or a first beamwidth (e.g., wide beamwidth), may be used for prediction of one or more beam resources in a second frequency range (e.g., FR2) and/or a second beamwidth (e.g., narrow beamwidth). As another example, AI/ML models and parameters may be used, updated, validated, verified, and/or tested for the beam prediction for a second set of beam resources. Associations between a first and a second set of beam resources may be applied, for example, the reported CRIs and their respective CSI parameters in a first frequency range (e.g., FR1) and/or a first beamwidth (e.g., wide beamwidth) may be used for deriving the association of the reported beam resources and one or more beam resources in a second frequency range (e.g., FR2) and/or a second beamwidth (e.g., narrow beamwidth). Further, AI/ML models and parameters may be used, updated, validated, verified, and/or tested for deriving respective associations. Also, CSI enhancement may be applied, for example, the reported CRIs and respective CSI parameters in a first frequency range (e.g., FR1) and/or a first beamwidth (e.g., wide beamwidth) may be used for deriving the enhanced CSI. As another example, AI/ML models and parameters may be used to derive an enhanced CSI (e.g., PMI Type II) based on the received/reported/determined CSI (e.g., PMI Type I) for a first set of CSI-RS resources (e.g., FR1 with wide beams).

The WTRU may report CSI using multiple parts for multiple CRI schemes, for example, to support multiple CRIs for CSI reporting. The WTRU may report CSI using multiple parts (e.g., a first part and a second part), and a payload size of a second part may be determined based on the information of a part associated with the first part (e.g., the first part). As an example, if the first part indicates a number of CRIs, the WTRU may determine a payload size of the second part as a number of CRIs * N (bits per CRI).

The WTRU may report associated wideband CSI parameters (e.g., one or more of RI, LI, wideband PMI, and wideband CQI) and/or subband CSI parameters (e.g., one or more of subband PMI and subband CQI) per CRI. As an example, the WTRU may report one or more of RI, LI, wideband PMI, subband PMI, wideband CQI, and subband CQI per CRI.

The WTRU may report CSI using three parts. As an example, Part 1 of the CSI reporting may indicate a number of CRIs. Part 2 may indicate wideband information (e.g., one or more of CRIs, RIs, LIs, wideband PMIs, and wideband CQIs). Part 3 may indicate subband information (e.g., one or more of subband PMIs, subband CQIs, etc.). The WTRU may determine a payload size of Part 2 based on a number of CRIs of Part 1. The WTRU may determine a payload size of Part 3 based on the reported information of Part 2. As another example, the WTRU may divide the CSI report into two parts, where Part 1 has a fixed payload size and is used to identify the number of information bits in Part 2. The WTRU may report the number of determined CRIs in part 1 for multiple CRI reporting.

The WTRU may report one or more CSI parameters (e.g., RI, CRI, CQI) of the determined CRIs in Part 1, wherein the CSI parameters are reported in the increasing order of indices allocated to the CRI that they are linked to. The WTRU may receive a configuration/indication of a number of CRIs for multiple CRI reporting.

In embodiments, the WTRU may report the entire CSI parameters corresponding to the CRI with the highest priority (e.g., index i=1) in Part 1. The WTRU may report one or more additional CSI parameters (e.g., RI, CRI, CQI) of the remaining CRIs in Part 1 (e.g., in case there is enough payload).

The WTRU may report CSI with more robust transmission schemes (e.g., based on lower modulation and lower coding schemes (MCS)) for one or more parts (e.g., Part 1 and/or Part 2) based on determined/configured priorities. As an example, the WTRU may transmit Part 1 with a first set of MCS, Part 2 with a second set of MCS, and Part 3 with a third set of MCS.

The WTRU may indicate the transmitted parts (e.g., Part 1, Part 2, or Part 3) as part of the report. Based on the indication, the gNB may identify a part that the gNB did not receive if the part is dropped/missed/corrupted. Based on the identification, the WTRU may receive an indication of the part of the CSI report for retransmission (e.g., based on one or more of RRC, MAC CE, and DCI).

The WTRU may report the CSI parameters for the determined CRIs with a differential scheme. As an example, the WTRU may order the determined CRIs based on the configured/predefined priority (e.g., RSRP, LOS, lowest/highest ID, etc.). The priority may be a decreasing order in which indices are assigned to each of the determined CRIs (e.g., i=1, 2, N, where i=1 is given to the CRI with the highest priority). The WTRU may report CSI parameters based on their assigned priority. As an example, the WTRU may report the CSI parameters for the CSI resource that are linked to the CRI with the highest priority (e.g., index i=1) in a first transmission instance/part. The WTRU may then report differential CSI parameters in a second transmission instance/part for other CSI resources (e.g., index i>1) with reference to the CSI parameters of the CSI resource that are linked to the CRI with the highest priority.

The WTRU may report multiple CRIs with a differential scheme. As an example, the WTRU may report a first CRI A, a difference D1 for a second CRI=A+D1, a difference D2 for a third CRI=A+D2, a difference D3 for a fourth CRI=A+D3, and so forth.

The WTRU may determine one or more levels of priority for reporting the CRIs. The reporting priority may be determined based on one or more parameters. As an example, in a gNB configuration/indication, a gNB may indicate the one or more levels of priority for reporting the CRIs based on one or more of RRC, MAC CE, and DCI to the WTRU.

As another example, the WTRU may determine the one or more levels of priority based on a use case. The use case may be one or more of a service type, e.g., URLLC (e.g., based on a configuration of URLLC CQI table), a measurement/reporting type, e.g., beam predictions/enhancements for FR1 and/or FR2 (e.g., based on AI/ML models), and whether the reporting is associated with other features, frequency ranges, bands, bandwidth parts and so forth (e.g., deriving FR1-FR2 associations, enhancement, and/or updates).

The WTRU may define an association between the probability/indication of LOS and the reported CRIs. As an example, the accuracy of beam selection by the WTRU may depend on LOS/NLOS indication. Beam selection/localization approaches may not be adequate if solely based on received signal strength (RSS) because this parameter may be negatively affected by multi-paths effects (e.g., scattering, diffraction, reflection, refraction, etc.). This is especially relevant in NLOS conditions where the received signal may not contain any direct line-of-sight component. In general, the RSS in LOS conditions may be greater than a hundred times stronger than the RSS in NLOS conditions. This divergence in signal strength may result in large estimation errors, either for best beam estimation/selection or for general localization problems to enable best beam selection.

The WTRU may be configured to help decrease the potential negative impact of multi-path effects. Specifically, NLOS conditions may need to be identified and subsequently mitigated. As an example, the WTRU may be configured with one or more CSI-RS resources for channel measurement and reporting. In a reporting configuration of the WTRU, the reportQuantity may be set to the “probability of LOS” for the reported CRIs. The indication of LOS/NLOS may be binary (e.g., one bit indication in UCI to indicate LOS versus NLOS scenario or a flag to indicate LOS scenario or a flag to indicate NLOS scenario) and/or it may be represented as a probability computed by the WTRU (expressed as a decimal or a percentage). The WTRU may be configured to report LOS and/or NLOS indication/probability in UCI to the network and/or as part of the CSI report.

The WTRU may be configured with an association between reported CRIs and probability/indication of LOS and/or NLOS such that most (if not all) reported CRIs might need to be accompanied by a corresponding probability/indication of LOS. The WTRU may be configured to report one or more CRI(s) corresponding to the one or more corresponding best beam(s). The WTRU may be configured to report the associated probability/indication of LOS/NLOS with every alternate reported CRI or every n reported CRI (where n≥2).

The WTRU may measure the probability of LOS and/or NLOS for one or more of the CSI-RS resources (e.g., based on precoding matrix, channel impulse response (CIR), etc.). The WTRU may be configured to report the probability/indication of LOS as a standalone parameter at every instant of reporting. Alternatively or additionally, the WTRU may be configured to report the differential of the probability/indication of LOS.

The WTRU may be configured to report the probability of LOS as a decimal/percentage point. In this configuration, the WTRU may report the first probability of LOS as a decimal/percentage point and subsequent values as the differential with respect to the initial value reported. As an example, the WTRU may select the best beam as the reference beam and report other CRIs with respect to the strongest beam, e.g., the WTRU may report a differential probability of LOS/NLOS for the different CRIs based on the beam with the highest probability of LOS.

The WTRU may be configured to report LOS/NLOS probability/indication periodically with periodicity pre-determined by the network or the WTRU. As an example, the periodicity of reporting of LOS/NLOS probability/indication may directly match the periodicity of reporting CRI(s) such that the reporting periodicity of LOS/NLOS may change if the reporting periodicity of CRI changes.

As another example, there may be multiple periodicities determined/configured at the WTRU for reporting the LOS/NLOS probability/indication and the reporting may be circumstantial, e.g., depending on some parameters. In such a configuration, for example, the periodicity of reporting of LOS probability/indication at the WTRU may be configured to be higher than the periodicity of reporting of NLOS probability/indication at the WTRU such that upon detection of an obstacle (e.g., object blocking the LOS), the WTRU may increase the reporting periodicity until the LOS conditions are restored.

The WTRU may be configured to report LOS/NLOS probability/indication upon detection of an ‘event.’ The ‘event’ may constitute any one or more of the (1) the probability of LOS is higher than a configured threshold for the CSI-RS resources, (2) the probability of NLOS is higher than a configured threshold for the CSI-RS resources, and (3) the change in LOS/NLOS condition has been detected by the WTRU. As an example, a sudden drop in measured RSRP with the corresponding CSI resources at the WTRU may indicate a transition from LOS to NLOS to the WTRU. As another example, a sudden rise in measured RSRP with the corresponding CSI resources at the WTRU may indicate a transition from NLOS to LOS to the WTRU.

The WTRU may report the CRI and measured probability of LOS for the respective CSI-RS resources where the probability of LOS may be higher than the configured threshold for one or more of the CSI-RS resources. As an example, the WTRU may be configured to report the LOS probability in decreasing order, starting with the strongest beam (e.g., having the highest LOS probability).

The WTRU may be configured to report the probability of NLOS when it drops below a configured threshold for one or more of the CSI-RS resources. Similarly, the WTRU may report the CRI and measured probability of NLOS for respective CSI-RS resources. As an example, the WTRU may be configured to report the NLOS probability in either increasing order (e.g., starting with the strongest beam) or in decreasing order (e.g., starting with the weakest beam).

In a configuration involving increasing/decreasing order reporting of CRI(s) and the corresponding LOS/NLOS probabilities, the WTRU may be configured to report every value in the stepwise increase/decrease (i.e., reporting of all the beams). The WTRU may also be configured to report every n (n≥2) value (i.e., reporting of every alternate beam in the case where n=2).

The WTRU may determine the number of CRIs for which the WTRU reports CSI parameters (e.g., LI, CQI, PMI, RSRP, SINR, RI, etc.) based on LOS/NLOS probability/indication, up to the maximum number of allowed CRIs. As an example, if the maximum number of allowed CRIs is N, the WTRU may report N CRIs for LOS scenarios and 1 CRI for NLOS scenarios.

The WTRU may determine the CSI resources to be reported in the CRIs based on the LOS/NLOS probability/indication. As an example, the WTRU may prioritize reporting CSI resources in CRIs corresponding to a LOS indication or in CRIs corresponding to a probability of LOS exceeding a configured threshold.

It is possible that higher carrier frequencies make propagation conditions harsher compared to lower carrier frequencies rendering transmissions (e.g., at mmWave frequencies) more susceptible to increased pathloss, channel intermittency and blockage by common objects.

A WTRU may be configured with one or more CSI-RS resources in a first frequency range (e.g., FR1) and/or a first beamwidth (e.g., wide beamwidth) for channel measurement and reporting. The measurement and reporting of CRIs in the first frequency range (e.g., FR1) and/or the first beamwidth (e.g., wide beamwidth) and the associated probability/indication of LOS/NLOS may be beneficial for beam selection/prediction in a second frequency range (e.g., FR2) and/or a second beamwidth (e.g., narrow beamwidth). Additionally, the WTRU may receive an indication from the network to report the associated probability/indication of LOS/NLOS with every reported CRI (versus every alternate CRI, for example) to assist the gNB with beam selection/prediction in a second frequency range (e.g., FR2) and/or a second beamwidth (e.g., narrow beamwidth).

In many scenarios involving LOS/NLOS reporting by the WTRU, the WTRU may receive an indication from the gNB to repeat measurement and reporting if the gNB determines the measurement/reporting to be inaccurate (e.g., based on CSI report on the selected beam from the WTRU and measurement of channel conditions at gNB). In the event that the WTRU is reporting LOS/NLOS conditions as a simple indication/flag, the WTRU may receive a request from the network to switch to more accurate soft reporting (with probabilities of LOS/NLOS). Alternatively, in the event the WTRU is reporting LOS/NLOS conditions in terms of probabilities/decimals to the gNB, it may receive an indication from the gNB that a simple indication/flag reporting may be sufficient in some scenarios (e.g., to reduce reporting overhead).

In embodiments for CSI enhancement based on multiple CRI reporting, the frequency range may be interchangeable with the frequency region. As an example, a configuration of cross-frequency-region measurement reporting may be used.

A WTRU may be configured to perform measurements in a first frequency region in order to support functions in a second frequency region. As an example, a WTRU may be configured with CSI-RS resources in FR1 on which to perform measurements to support Beam Management (BM) in FR2.

A first frequency region or FR1 may be considered as a frequency band of a lower frequency region (e.g., below 7125 MHz) and a second frequency region or FR2 may be considered as a frequency band of a higher frequency region (e.g., 24.25 GHz and above). However, the actual range of each frequency region may not be fixed and may be configurable. As such, the cross-FR function may be used to describe a cross-FR-feedback-based function.

The cross-FR measurement reporting configuration may include multiple parameters. Reference signal resources (e.g., CSI-RS) on which to perform cross-FR measurements may be located in a first FR (e.g., FR1) or a second FR (e.g., FR2). In embodiments, the WTRU may be configured with an association of CSI-RS resources in a first FR (e.g., FR1) and CSI-RS resources in a second FR (e.g., FR2).

A WTRU may be configured with one or more CSI reporting resources. The parameters of the one or more CSI reporting resources may include measurement report values. A WTRU may be provided with a set of measurement report values associated with one or more cross-FR functions. As an example, the measurement report values may include at least one of: RSRP, RSSI, RSRQ, Channel occupancy, RI, CQI, PMI, CRI, LI. Measurement report value suitability may apply, for example, wherein a WTRU may be configured with a suitability criterion that indicates whether an FR1 measurement may be used to support an FR2 function.

A WTRU may be configured with criteria to select the CSI reporting resources that may apply. As an example, a WTRU may determine the CSI reporting resources as a function of one of: measurement type, measurement value, payload size, associated cross-FR function, CSI-RS resource, or priority. As an example, the criteria to select the measurement report value may be based on a WTRU determining the measurement report value(s) as a function of one of: measurement type, measurement value, payload size, associated cross-FR function, CSI-RS resource, or priority.

A further parameter of the one or more CSI reporting resources may be a cross-FR function. As an example, the cross-FR measurement reporting may enable a WTRU to report measurements in FR1 to support a cross-FR function in FR2. The cross-FR function may include at least one of: Beam Management (e.g., beam prediction or beam association), Radio Link Monitoring. Cell (re)selection, BWP management, Mobility, Conditional Hand-Over (HO), Scheduling, and so forth. In embodiments, an AI/ML model may apply.

As another example, a WTRU may be configured with an AI/ML model to perform cross-FR measurements. The model may use WTRU measurements performed on CSI-RS in a first FR and output values in support of a function in a second FR. The WTRU may report/indicate the output values to the gNB. As an example, the AI/ML model for cross-FR measurements may be specific to WTRU implementation. As another example, the AI/ML model may be configured by a network (NW). As another example, the WTRU and NW may exchange assistance information to determine if a WTRU based AI/ML model or NW configured AI/ML may be used. The WTRU may be configured to (re) train or fine tune implementation AI/ML model based on measurements and/or assistance data from the network. The assistance data may be inferred from the beam management commands from NW for FR2 and RS measurements in FR1. The NW configured AI/ML model may be used as a fallback if WTRU based AI/ML model doesn't meet performance requirements.

The WTRU may be configured to fallback to legacy reporting in the absence of NW configured AI/ML model if the WTRU based AI/ML model doesn't meet performance requirements.

The WTRU may be configured with a plurality of AI/ML models and each AI/ML model may be associated with preconfigured measurement set in the first frequency range (e.g., FR1). The WTRU may be configured to select an AI/ML model based on the specific measurement set configured for cross-FR operation. As an example, different AI/ML models may be dimensioned (e.g., input sizes) for different number/periodicity/density/type of RS in the first frequency range (e.g., FR1).

The WTRU may be configured with additional AI/ML model parameters, including accuracy requirements. The accuracy requirements may enable the WTRU to determine the suitability of an FR1 RS measurement to support cross-FR functionality. The additional AI/ML parameters may further include AI/ML model (re) training parameters or resources, triggers to (re) train the AI/ML model and resources on which the WTRU may request for an AI/ML model (re) training.

A WTRU may perform measurements on one or more RS resources in a first FR to support a function in a second FR. Cross-FR measurement and reporting may include measurement sets and subsets. As an example, the set of measurements that a WTRU may perform may include L1 or L3 measurements (e.g., RSRP, RSSI, RSRQ, Channel occupancy, RI, CQI, PMI, CRI, LI). As another example, a WTRU may perform a measurement on a combination of one or more RS resources in a first FR and one or more associated RS resources in a second FR.

A WTRU may obtain a set of measurements S1 on a set of RS resources in a first FR and possibly a set of associated RS resources in a second FR. As an example, a WTRU may be configured with a first CSI-RS in FR1 associated with a second CSI-RS in FR2 and a third CSI-RS in FR1. The WTRU may obtain the set of measurements S1 as a first measurement obtained from the first and second CSI-RS resources and a second measurement obtained from the third CSI-RS resource. As another example, a WTRU may be configured with a first CSI-RS in FR1, a second CSI-RS in FR1, and a third CSI-RS in FR1. The WTRU may obtain the set of measurements S1 as a first measurement obtained from the first CSI-RS resource, a second measurement obtained from the second CSI-RS resource, and a third measurement obtained from the third CSI-RS resource.

The set of measurements S1 may be composed of subsets of measurements S1x (e.g., S11, S12, S13, etc.). Each subset S1x in S1 may be associated with a single CSI-RS in a first FR, a set of CSI-RSs in FR1, or a pair of associated CSI-RS (one or more in a first FR and one or more in a second FR). Each subset of measurements may include different types of measurement values (e.g., RSRP, RSSI, RSRQ, Channel occupancy, RI, CQI, PMI, CRI, LI).

A WTRU may be configured with a measurement suitability criterion. Such a criterion may enable the WTRU to determine whether a measurement in S1 (e.g., in a first frequency range, (e.g., FR1)) is suitable to be used to support a cross-FR-feedback-based function such as beam management (e.g., in a second frequency range, (e.g., FR2)).

The WTRU may determine if one or more measurements in S1 or measurement subsets (S1x) is suitable based on one or more suitability criteria. The suitability criteria may include a comparison to a threshold. As an example, if a measurement is below or above a possibly configurable threshold, the WTRU may determine that the measurement is suitable. As another example, the WTRU may compare the CQI of a subset S1x to a threshold value and if the CQI value is above a threshold, the WTRU may determine that measurements in S1x are suitable.

As another example, a WTRU may determine that a measurement or measurement subset is suitable if its value is within a threshold offset from that of another measurement (i.e., taken on a different RS resource) or of another measurement subset. As an example, the WTRU may obtain the CQI in S11 and may deem S12 suitable if its CQI is greater than or equal to an offset threshold from the CQI in S11.

The suitability criteria may include an indication from gNB, wherein a WTRU may receive an indication from a gNB that one or more measurements or measurement subsets are suitable. The indication may be done via CRI. As an example, the gNB may provide a list of CRI values to the WTRU to indicate which measurements or measurement subsets are suitable.

The WTRU may receive an implicit indication that the cross-FR measurements are feasible. The WTRU may receive an activation and/or deactivation command associated with the AI/ML models configured for cross-FR operation. As an example, the WTRU may assume that the measurement subsets are suitable if the WTRU receives an activation command for the associated AI/ML model. Alternatively, the WTRU may assume that the measurement subsets are not suitable if the WTRU receives a deactivation command for the associated AI/ML model.

The suitability criteria may include the performance of cross-FR-feedback-based functions. As an example, a WTRU may determine that one or more measurements or measurement subsets (possibly obtained on resources of a first FR) are suitable based on the performance of a function in a second FR. If the WTRU determines there is beam failure in FR2, the WTRU may determine that one or more measurements or measurement subsets are no longer suitable. If the WTRU determines that the block error rate (BLER) performance is above (or below) a threshold for transmissions in FR2, the WTRU may determine that one or more measurements or measurement subsets are suitable (or not suitable).

Another suitable criteria may be a confidence value associated with AI/ML model. As an example, the WTRU may be configured with AI/ML model whose output predictions may be associated with a confidence value. The confidence value may indicate the likelihood of cross-FR prediction meeting/exceeding a specific performance threshold. As an example, the confidence value may be expressed in percentage or real number between 0 and 1.

The WTRU may assume that the measurement subsets are not suitable if the confidence value associated with AI/ML model output is below a preconfigured threshold.

A WTRU may determine that a change in measurements may be a suitable criteria. As an example, the WTRU may determine that a measurement is suitable based on the measurement changing (or not changing) by more than a threshold value compared to a previous instance of the measurement.

A WTRU may determine that a function of reception or detection of a new RS is a suitable criteria. As an example, a WTRU may determine the set (or size thereof) of suitable measurements or measurement subsets based on the number of detected RS.

A WTRU may provide a triggering report to the gNB concerning a measurement or a measurement subset if a measurement or a measurement subset is deemed suitable.

The WTRU may use an AI/ML encoder to determine a feedback report or report value for the RS resource(s) associated with a measurement or measurement subset if the measurement or measurement subset is deemed suitable.

The WTRU may determine whether to report feedback enabling cross-FR functionalities if at least one of (1) one or more measurements or measurement subsets are suitable, (2) at least x (x>1) measurements or measurement subsets are suitable, (3) an indication from gNB to report such feedback, (4) a determination based on the performance of a cross-FR function. As an example, if the cross-FR function is not failing, the WTRU may report feedback enabling cross-FR functionality, and a confidence value associated with AI/ML model output is above a preconfigured threshold. The WTRU may be configured specifically for measurement report triggering.

A WTRU may be configured to determine the content of a feedback enabling cross-FR functionality report. As an example, the WTRU reports may include an indication to the gNB that cross-FR feedback is being reported. As another example, the WTRU may report a request to activate reporting of feedback enabling cross-FR functionality.

The WTRU reports may include an indication that AI/ML encoding, or decoding is used. The reports may include an indication of the AI/ML model index and the like and/or an indication that the gNB may activate its AI/ML model (e.g., AI/ML decoder).

The reports may include a priority of a measurement or measurement subsets. A payload of the reporting resources may apply. As an example, a WTRU may determine to report a subset S2 of the suitable measurements or measurement subsets. The WTRU may determine S2 as a function of at least one of: the payload of the reporting resource, the priority of the measurement(s), measurement subset(s) S1x, maximum allowed CRIs or measurement subsets S1x, or the measurement types.

The reports may include at least one measurement from at least one of the suitable measurement subsets. As an example, the CRI may be reported for each of the suitable measurement subsets. As another example, the WTRU may determine the measurement(s) or measurement type(s) to be reported as a function of at least one of: feedback resource payload, priority of the measurement or measurement subset S1x, number of suitable measurements or measurement subsets S1x. As another example, a WTRU may determine to transmit Type I PMI if there are more than X suitable measurements or measurement subsets S1x, and Type II PMI if there are less than (or equal to) X suitable measurements or measurement subsets S1x.

The WTRU may relate the reports to the timing of the resource(s) used to obtain the measurement, the associated cross-FR function that the measurement supports (e.g., Beam Management, RLM, mobility, L3 measurements, scheduling, BWP management, HO, and so forth) and/or the confidence value associated with AI/ML output.

A WTRU may determine not to report feedback enabling cross-FR functions and the WTRU may report an indication to the gNB that it will not report feedback enabling cross-FR functionality. Similarly, the WTRU may report a request to the gNB to deactivate cross-FR feedback.

A WTRU may request other RS resources to support cross-FR functionality. As an example. the WTRU may determine that no measurements or measurement subsets (or less than X measurements or measurement subsets) are suitable. In such a case, the WTRU may request additional RS resources in order to increase the likelihood that more than X measurements or measurement subsets are suitable. Such RS resources may be requested to be in a first or second FR.

A WTRU may report measurements to support functions in the same FR as the measurement resources. As an example, the WTRU may report legacy or fallback CSI reports. The WTRU may multiplex the feedback for legacy or same-FR and cross-FR functionality into a single feedback resource. The WTRU may determine to compress or drop some or all of the legacy or same-FR or cross-FR enabling report types or values as a function of a priority associated with each type of feedback and feedback payload.

A WTRU may report the at least one suitable measurement, or the output of the AI/ML encoder (e.g., for the suitable measurements), or an indication that feedback for cross-FR functions is reported, or any of the above list, in a feedback resource. The feedback resource may include a PUCCH resource. As an example, the WTRU may be configured with a PUCCH resource or resource type to indicate that cross-FR feedback is reported or that AI/ML-based feedback is reported.

As another example, a PRACH resource may be included. The WTRU may be configured with a PRACH resource in a first or second FR to indicate that cross-FR feedback is triggered or supported or reported by the WTRU. Additionally, or alternatively, a PUSCH resource, a MAC CE and/or a HARQ feedback may apply. As an example, a WTRU may report an indication of activation or deactivation of cross-FR feedback in a HARQ feedback report.

A WTRU may determine that a function in a second FR supported by cross-FR feedback has failed. As an example, the WTRU may be configured with measurements in a first FR to support beam management in a second FR and that beam failure has occurred in the second FR. As another example, a WTRU may be configured with sparse resources in the second FR to periodically or periodically validate measurements or AI/ML outputs performed or obtained in a first FR.

A WTRU may determine if a cross-FR-feedback-based function has failed based on a validation criterion. The validation criterion may include a determination that (1) the output of the function based on cross-FR feedback is different from the output of the same function based on same-FR measurements, (2) a measurement on an RS resource in a second FR is different by an offset value from an associated measurement on an RS resource in a first FR, (3) a WTRU performance metric (e.g., BLER performance, throughput, latency, HARQ-ACK/NACK ratio, spectral efficiency) based on a cross-FR feedback is different by an offset value from that expected based on a same-FR measurement, and/or (4) statistics associated with confidence level of AI/ML model at the WTRU is below a preconfigured threshold (for example, the statistics may include an average value over a time period, minimum value, median value over a time period, and so forth).

A WTRU may indicate a failure to the gNB in the event of a cross-FR-feedback-based function failure. In response to such a failure, the WTRU may (1) stop cross-FR feedback reporting, (2) request resources in a first FR to enhance or improve cross-FR feedback reporting, (3) request resources in a second FR to enable measurements and feedback reporting in the second FR to support the function in the second FR, (4) receive or detect or measure RS resources in a second FR, (5) report feedback for measurements performed on RS resources in a second FR, and/or (6) indicate or request fallback to legacy type second FR functionality. As an example, if the WTRU is configured with BM in a second FR supported by measurements in a first FR, it may request to begin BM in a second FR to be supported by measurements (e.g., fallback/legacy measurements) in a second FR. If failure is detected, the WTRU may request an update to an AI/ML model and/or may begin (re) training an AI/ML model.

A WTRU may request resources to (re) train an AI/ML model supporting cross-FR functionality. With reference to these resources, the WTRU may be configured with RS resources in a first FR associated with RS resources in a second FR. The WTRU may input into an AI/ML model measurements obtained from the RS resources in the first FR and possibly a subset of measurements obtained from the RS resources in the second FR. The WTRU may test the outcome of the AI/ML model against the expected outcome determined based on measurements obtained on RS resources in the second FR.

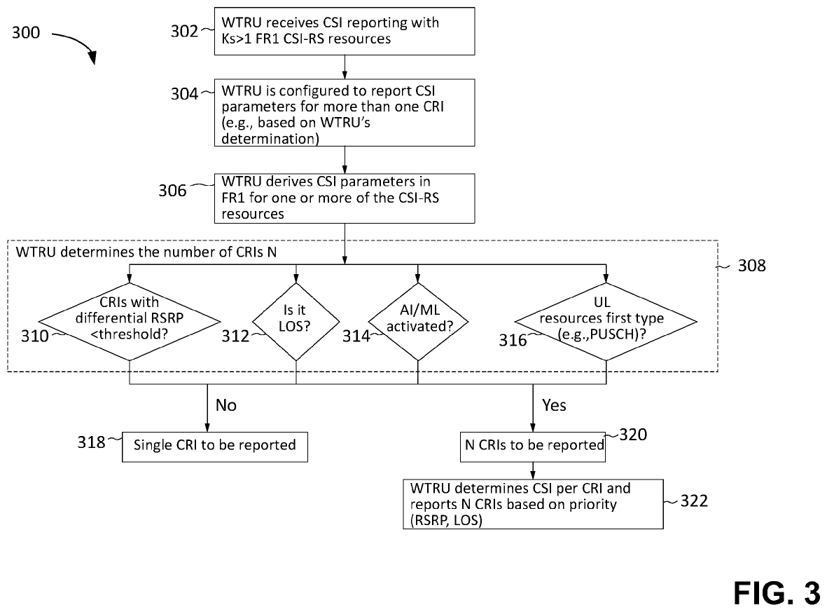

FIG. 3 illustrates an example procedure 300 for supporting multiple CSIs for CSI measurement in beam prediction. The procedure 300 may be performed by a WTRU. The WTRU may support multiple CRIs for CSI measurement. The WTRU may receive CSI reporting configuration with K>1 FR1 CSI-RS resources at 302. As an example, the CSI-ReportConfig may be configured with the higher layer parameter reportQuantity set to ‘cri-RI-PMI-CQI’, ‘cri-RI-i1’, ‘cri-RI-i1-CQI’, ‘cri-RI-CQI’, ‘cri-RI-LI-PMI-CQI’, and/or other relevant parameters. The WTRU may be configured with CSI report configuration information (e.g., CSI-ReportConfig), and Ks>1 CSI-RS resources are configured for FR1 in the corresponding resource set for channel measurement (e.g., where Ks may represent the CSI-RS resources).

The WTRU may be configured to report CSI parameters for more than one CRI (e.g., based on a WTRU's determination) at 304. The CSI reporting configuration (e.g., received at 302) may include an indication of the maximum limit for the number of CRI to be reported. The CSI reporting configuration may include an indication of the priority for multiple CRI reporting (e.g., RSRP, LOS, etc.). The CSI reporting configuration may include a threshold(s) (e.g., differential) for the indicated priorities, where for example, the threshold(s) may be based on an AI/ML model.

The WTRU may derive CSI parameters in FR1 for one or more of the CSI-RS resources at 306. The WTRU may be configured with nrofReportedRS for the number of CRIs to be reported (e.g., N), the indication/probability of LOS for the reported CRIs, and/or other relevant parameters.

The CSI reporting configuration (e.g., received at 302) may include one or more of an indication of the maximum limit for the number of CRI to be reported, an indication of the priority for the multiple CRI reporting (e.g., based on RSRP, an Indication of LOS, probability of LOS, and other relevant parameters, and one or more thresholds and/or differential thresholds, for the indicated priorities, based on AI/ML model in gNB).

The WTRU may determine the number of CRIs N at 308 (e.g., a single CRI or multiple (N) CRIs). For example, the WTRU may determine the number of CRIs N at 308 based on any combination of criteria (e.g., as described in reference to 310, 312, 314, and 316). For instance, the WTRU may determine one or more applicable priority criteria and/or may determine the number of CRIs N (e.g., up to the maximum number of allowed CRIs) for which the WTRU reports the CSI parameters based on measurements and/or AI/ML parameters.

For example, the WTRU may use RSRP measurements when determining the number of CRIs N at 310 (e.g., N for when there are at least two CRIs with CRI-RSRP higher than a first configured threshold and that their difference is lower than a second configured threshold, 1 otherwise).

The WTRU may determine the number of CRIs N based on a LOS

indication/probability criteria at 312. For example, the WTRU may determine the number of CRIs based on LOS indication (e.g., N for LOS and 1 for NLOS). The parameters may further be based on UL resources for CSI reporting and on UL resource type (e.g., if the UL resource is a first type (e.g., PUSCH).

In some examples, the WTRU may determine the number of CRIs N based on whether AI/ML is activated or deactivated at 314 (e.g., N for when AI/ML is activated and 1 for when AI/ML is deactivated).

The WTRU may determine the number of CRIs N based on the type of UL resources at 316 (e.g., whether the UL resources are of a particular type, such as PUSCH resources). For example, if the UL resources are of a first type, the WTRU may report N CRIs, while if the UL resources are of a second type (e.g., PUCCH), the WTRU may report a single CRI.

At 310, the WTRU may determine to report a single CRI (e.g., based on the factors considered at 308). At 312, the WTRU may determine to report N CRIs (e.g., based on the factors considered at 308). If the WTRU determines to report N CRIs at 308, the WTRU may determines CSI per CRI and reports N CRIs based on priority (e.g., RSRP and/or LOS). For example, the WTRU may determine CSI resources to be reported in CRIs based on priority, such as RSRP, LOS indication/probability and/or configured priority. Regarding RSRP, the WTRU may determine the CSI resource with the highest CRI-RSRP as a reference (e.g., CRI-RSRP-ref). The WTRU may determine CRI corresponding to other CSI resources, conditioned that their difference with the reference CRI-RSRP (e.g., CRI-RSRP-ref), is lower than a first threshold. For LOS indication/probability, the WTRU may determine CRI of the CSI resources for which the probability of having LOS is equal or above a second threshold. The WTRU may further order the determined CRIs based on the configured priority (e.g., RSRP, LOS, etc.) in a decreasing order and give them indices (e.g., i=1, 2, N, where i=1 is given to CRI with highest priority).

As shown in FIG. 3, the WTRU may report CSI parameters for the CSI-RS resources in FR1 that are linked with the determined CRIs. The WTRU may derive CSI parameters (e.g., any combination of LI, CQI, PMI, RSRP, SINR, RI, etc.) in FR1 for one or more of the CSI-RS resources.

The gNB may process the FR1 CSI reports for further actions. As an example, the gNB may make beam predictions/enhancements for FR2 based on AI/ML models. As another example, the gNB uses FR1 CRI wider beam and respective PMI's narrow beam for FR2 beam predictions. As another example, the gNB may derive/update FR1-FR2 associations (e.g., spatial hierarchical relations).

A WTRU may divide CSI reporting to support multiple CRIs. The WTRU may divide the CSI reporting for multiple CRI schemes in more than one part, e.g., due to limits in UCI/UL resources allocated for CSI reporting. As an example, the WTRU may divide the CSI report into three parts, where Part 1 indicates a number of CRIs, Part 2 indicates wideband information (e.g., one or more of CRI, RI, LI, wideband PMI, and wideband CQI), and Part 3 indicates subband information (e.g., one or more of subband PMI, subband CQI, etc.).

As another example, the WTRU may divide the CSI report into two parts, where Part 1 has a fixed payload size and is used to identify the number of information bits in Part 2. With this configuration, the WTRU may report the number of determined CRIs in part 1 for multiple CRI reporting. As an example, the WTRU may additionally report one or more CSI parameters (e.g., RI, CRI, CQI) of the determined CRIs in the CSI Part 1, wherein the CSI parameters are reported in the increasing order of indices allocated to the CRI that they are linked to.

As another example, the WTRU may report the entire CSI parameters corresponding to the CRI with the highest priority (e.g., index i=1) in Part 1. The WTRU may additionally report one or more CSI parameters (e.g., RI, CRI, and CQI) of the remaining CRIs in the CSI Part 1 (e.g., in case there is enough payload).

The WTRU may determine to use more robust transmission (e.g., based on modulation and coding schemes (MCS)) for one or more parts (e.g., Part 1) based on determined/configured priorities.

The WTRU may indicate the transmitted parts (e.g., Part 1, 2, or 3) as part of the report. With this configuration, the different transmitted parts may be followed and if a transmitted part is dropped/missed/corrupted, it may be identified.

A WTRU may (e.g., optionally) report the CSI parameters for the determined CRIs in a differential scheme. The WTRU may order the determined CRIs based on the configured priority (e.g., RSRP, LOS, etc.) in a decreasing order and give them indices (e.g., i=1, 2, N, where i=1 is given to CRI with highest priority). As an example, the WTRU may first report the CSI parameters for the CSI resource that is linked to the CRI with the highest priority (e.g., index i=1). As another example, the WTRU may then report differential CSI parameters for other CSI resources with a lower priority (e.g., index i>1), with reference to the CSI parameters of CSI resource that is linked to the CRI with the highest priority.

A WTRU may determine one or more levels of priority for reporting the CRIs. The reporting priority may be determined based on the use-case that CSI-reporting desired at the gNB, e.g., beam predictions/enhancements for FR1 and/or FR2 (e.g., based on AI/ML models) and/or deriving FR1-FR2 associations, enhancement, and/or updates.

A WTRU may be configured with an association of probability/indication of LOS and reported CRIs. The WTRU may be configured with one or more FR1 CSI-RS resources for channel measurement and reporting. In reporting configuration, the reportQuantity may be set to the “probability of LOS” for the reported CRIs, and respective thresholds based on the AI/ML configurations. The WTRU may then measure the probability of LOS for one or more of the CSI-RS resources, e.g., based on a precoding matrix, a channel impulse response (CIR), etc. In case the probability of LOS is higher than the configured threshold for one or more of the CSI-RS resources, the WTRU may report the CRI and the measured probability of LOS for respective CSI-RS resources, e.g., the WTRU reports the probability of LOS in a decreasing order and/or the WTRU may report the differential probability of LOS reported for the CRIs based on the reference beam (with highest probability of LOS). The gNB may use the received information for further procedures.

A WTRU may be configured with support for multiple CRI reporting for CSI enhancement in, e.g., FR1. A WTRU may be configured with one or more CSI-RS resources for channel measurement and reporting. As an example, the WTRU may be configured to report the PMI (e.g., Type II PMI). As another example, the WTRU may be configured with AI/ML model parameters at the gNB, including accuracy requirements, set of use cases, thresholds, and so forth. As another example, the WTRU may derive CSI parameters (e.g., LI, CQI, PMI, RSRP, SINR, RI, and so forth) for one or more of the CSI-RS resources, where the respective CRIs may be determined based on the configured entries of associated nzp-CSI-RS-Resources in the corresponding NZP-CSI-RS-ResourceSet for channel measurement.

A WTRU may determine if the CSI reporting can be performed based on AI/ML model at the gNB or legacy (e.g., fallback) CSI reporting. In case the measured CSI parameters corresponding to one or more of the CRIs are higher than a first threshold, the WTRU may determine the respective CRIs to be reported. As an example, the WTRU may send an activation request for the AI/ML model at the gNB. The WTRU may report CSI parameters for one or more of the determined CRIs (e.g., based on priority, maximum allowed CRIs, and/or UCI payload limitations). As another example, instead of reporting Type II PMI with a large payload, the WTRU may report Type I PMI for one or more CRIs with a lower payload overall. A gNB may receive the reported CSI parameters and performs CSI estimation based on AI/ML models. In the case that the measured CSI parameters corresponding to one or more of the CRIs are not higher than a first threshold, the WTRU may send a deactivation request for the AI/ML model at the gNB. The WTRU may also report CSI parameters for the fallback/legacy CSI reporting. Alternatively or additionally, the WTRU may be configured with AI/ML model at the WTRU, where the WTRU can use the AI/ML model for beam prediction enhancements, beam associations enhancement, and any other relevant functions.

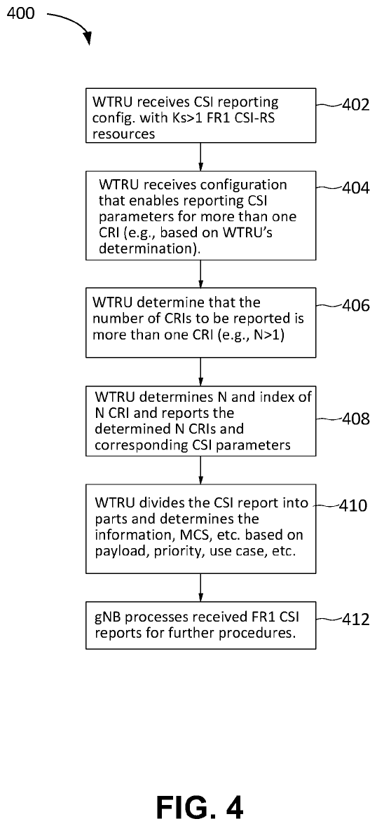

FIG. 4 is a flow chart for a procedure 400 performed by a WTRU for supporting multiple CRIs in CSI measurement and reporting. At 402, the WTRU may receive a CSI reporting configuration with more than one (e.g., Ks>1) CSI-RS resources (e.g., FR1).

At 404, the WTRU may receive configuration information that enables reporting CSI parameters for more than one CRI. The configuration information may include a maximum number of CRIs to be reported (e.g., nrofReprtedRs), priority levels, thresholds for RSRP, probability of LOS, and/or any other relevant measurements, for example, as described above.

At 406, the WTRU may derive CSI parameters for a first set of configured CSI-RS resources (e.g., FR1). At 408, the WTRU may determine that the number of CRIs to be reported is more than one CRI (e.g., N>1). As an example. the WRTU may determine to report one or multiple CRIs based on factors that include an AI/ML model that is activated, if RSRP is greater than a threshold defined for multiple CRIs, if a probability of LOS is greater than a threshold for multiple CRIs, and if UL resources for reporting is a first type (e.g., PUSCH).

At 410, if it is determined to report more than one (e.g., N>1) CRI, the WTRU may determine a number (e.g., N) of CRIs to report and an index for the N CRIs and may report the N CRIs along with their corresponding CSI parameters. As an example, the WTRU may determine to report the N CRIs with the highest RSRP. As another example, the WTRU may determine to report the N CRIs with the highest probability of LOS.

At 412, the WTRU may divide the CSI report into parts and determine the information and modular coding scheme of each part based on payload, priority, use cases, or other relevant factors.

The WTRU may determine to report a number of best CRI and corresponding CSI parameters in a first part and to report other CRIs in other parts.

The report may be comprised of three parts. the first part containing the number (e.g., N) of CRIs reported, the second part containing information on wideband CSIs, and the third part containing information on subband CSIs.

The WTRU may determine to use robust modular coding schemes for a first part of the report and use other coding schemes for the remaining parts of the report.

As used herein, the 3GPP standards terms and information elements described and used in this document are to be interpreted consistent with their meaning as commonly used in industry. For example, the following 3GPP standards documents are incorporated by reference herein, and the terms should be interpreted consistently with their meaning in those documents: 3GPP TS 38.213, “NR Physical layer procedures for control” V16.10.0; 3GPP TS 38.321, “Medium Access Control (MAC) protocol specification” V16.9.0; 3GPP TS 38.331, “Radio Resource Control (RRC) protocol specification” V16.9.0; and 3GPP TS 38.211, “NR Physical Channels and Modulation,” v16.10.0. However, the terms and concepts disclosed herein include terms and concepts not disclosed or described in those standard documents, and thus the concepts and terms herein are not meant to be solely limited to how such terms are used in the existing standards. Rather, these standards are referenced to the extent necessary in order to provide a reference for understanding the background of terms used herein.

The processes and instrumentalities described herein may apply in any combination to other wireless technologies and for other services. A WTRU may refer to an identity of the physical device, or to the user's identity such as subscription related identities, e.g., MSISDN, SIP URI, etc. WTRU may refer to application-based identities, e.g., user names that may be used per application.

The processes described above may be implemented in a computer program, software, and/or firmware incorporated in a computer-readable medium for execution by a computer and/or processor. Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as CD-ROM disks, and/or digital versatile disks (DVDs). A processor in association with software may be used to implement a radio frequency transceiver for use in a WTRU, UE, terminal, base station, RNC, and/or any host computer.

What is claimed is:

1. A method performed by a wireless transmit/receive unit (WTRU), the method comprising:
receiving configuration information, wherein the configuration information indicates channel state information (CSI) reporting parameters used for reporting a plurality of CSI reference signal (CSI-RS) resource indicators (CRIs), and wherein the configuration information indicates one or more parameters used to determine a number of CRIs to report, the one or more parameters comprising a line of sight (LOS) probability threshold;
determining CSI parameters for a first set of configured CSI-RS resources associated with a first CRI;
determining CSI parameters for one or more additional sets of configured CSI-RS resources associated with one or more additional CRIs based on a determined LOS probability for the CSI parameter associated with the first set of configured CSI-RS resources being greater than the LOS probability threshold; and
transmitting the CSI parameters associated with the first CRI and the CSI parameters associated with the one or more additional CRIs.

2. The method of claim 1, wherein the configuration information indicates a maximum value for the plurality of CRIs.

3. The method of claim 1, wherein the configuration information indicates one or more priority levels for selecting the one or more additional CRIs.

4. The method of claim 3, wherein the priority levels comprise one or more of a reference signal received power (RSRP) criteria, a LOS indication criteria, or a LOS probability criteria.

5. The method of claim 3, wherein the priority levels comprise one or more use cases for the additional sets of CSI-RS resources, the one or more use cases comprising ultra-reliable low latency (URLLC) access, services relying on enhanced massive mobile broadband (eMBB) access, or services for machine type communication (MTC) access.

6. The method of claim 1, wherein determining the CSI parameters for the one or more additional sets of CSI-RS resources associated with the one or more additional CRIs is further based on a schedule for an uplink resource or the uplink resource type.

7. The method of claim 1, wherein the first CRI and the CSI parameters associated with the first CRI are transmitted in a first feedback resource, and the one or more additional CRIs and the CSI parameters associated with the one or more additional CRIs are transmitted in a second feedback resource.

8. The method of claim 1, wherein the one or more additional CRIs are associated with a second set of configured CSI-RS resources, and the second set of CSI-RS resources is determined based on one or more of a priority, reference signal received power (RSRP) measurements, or a LOS probability.

9. The method of claim 1, wherein the CSI parameters associated with the first CRI comprise channel quality indication (CQI) feedback, precoding matrix indices (PMI), a rank indicator (RI), or a layer index (LI), and wherein the CSI parameters associated with the one or more additional CRIs comprises CQI feedback, PMI, a RI, or a LI.

10. A wireless transmit/receive unit (WTRU) comprising:
a processor configured to:
receive configuration information, wherein the configuration information indicates channel state information (CSI) reporting parameters used for reporting a plurality of CSI reference signal (CSI-RS) resource indicators (CRIs), and wherein the configuration information indicates one or more parameters used to determine a number of CRIs to report, the one or more parameters comprising a line of sight (LOS) probability threshold;
determine CSI parameters for a first set of configured CSI-RS resources associated with a first CRI;
determine CSI parameters for one or more additional sets of configured CSI-RS resources associated with one or more additional CRIs based on a determined LOS probability for the CSI parameter associated with the first set of configured CSI-RS resources being greater than the LOS probability threshold; and
transmit the CSI parameters associated with the first CRI and the CSI parameters associated with the one or more additional CRIs.

11. The WRTU of claim 10, wherein the configuration information indicates a maximum value for the plurality of CRIs.

12. The WRTU of claim 10, wherein the configuration information indicates one or more priority levels for selecting the one or more additional CRIs.

13. The WRTU of claim 12, wherein the one or more priority levels comprise one or more of a reference signal received power (RSRP) criteria, a LOS indication criteria, or a LOS probability criteria.

14. The WRTU of claim 12, wherein the one or more priority levels comprise one or more use cases for the additional sets of configured CSI-RS resources, the one or more use cases comprising ultra-reliable low latency (URLLC) access, services relying on enhanced massive mobile broadband (eMBB) access, or services for machine type communication (MTC) access.

15. The WRTU of claim 10, wherein determination of the CSI parameters for the one or more additional sets of configured CSI-RS resources associated with the one or more additional CRIs is further based on an uplink resource schedule or the uplink resource type.

16. The method of claim 10, wherein the first CRI and the CSI parameters associated with the first CRI are transmitted in a first feedback resource, and the one or more additional CRIs and the CSI parameters associated with the one or more additional CRIs are transmitted in a second feedback resource.

17. The method of claim 10, wherein the one or more additional CRIs are associated with a second set of configured CSI-RS resources, and the second set of CSI-RS resources is determined based on one or more of a priority, reference signal received power (RSRP) measurements, or a LOS probability.

18. The method of claim 10, wherein the CSI parameters associated with the first CRI comprises channel quality indication (CQI) feedback, precoding matrix indices (PMI), a rank indicator (RI), or a layer index (LI), and wherein the CSI parameters associated with the one or more additional CRIs comprises CQI feedback, PMI, a RI, or a LI.
